(19) United States
(12) Patent Application Publication
(10) Pub. No.: US 2009/0110511 A1
(43) Pub. Date: Apr. 30, 2009

(54) ELASTIC FASTENER

(76) Inventor: Chia-Chun CHENG, Chung-Ho City (TW)

Correspondence Address: HDLS Patent & Trademark Services, P.O. BOX 220746, CHANTILLY, VA, 20153-0746, US

(21) Appl. No.: 12/169,053

(22) Filed: Jul. 8, 2008

(30) Foreign Application Priority Data
Oct. 25, 2007 (TW) 096217885

(51) Int. Cl. F16B 21/10

(52) U.S. Cl. 411/349

(57) ABSTRACT

An elastic fastener for fixing a heat sink on a circuit board includes a fixing element, a cylinder and an elastic element. The fixing element has a head and a fixing section. One side of the fixing section is formed into a protruding ring. The cylinder is made of electrically non-conductive materials and it has a hollow hole for allowing the fixing element to pass through. The cylinder extends inwardly to form a locking ring for engagingly connecting with the protruding ring. The elastic fastener further includes an elastic element. Both ends of the elastic element are elastically compressed between the head and the top surface of the cylinder. With the above arrangement, the electrically non-conductive property of the cylinder can prevent the circuit board and the heat sink from contacting to generate a short circuit and in turn cause a breakdown of the circuit board. Furthermore, the elastic force of the elastic element can prevent the force of fixing the heat sink on the circuit board from being too large. Thus, the circuit board can be protected form suffering damage.

### BACKGROUND OF THE INVENTION

1. Field of the Invention

The present invention relates to an elastic fastener, and in particular to an elastic fastener for fixing a heat sink on a circuit board.

2. Description of Prior Art

Electronic elements (such as central processors) generate a large amount of heat in operation. If the generated heat is not dissipated immediately, the accumulation of heat will increase the temperature of the working environment in which these electronic elements are operating. Even, the normal operation of the electronic element will be affected substantially. Therefore, a heat sink is usually fixed on the surface of such a heat-generating electronic element, thereby dissipating the heat. The heat sink can be combined with the circuit board via special fasteners. However, such a manner has to increase the cost of molds for manufacturing the fasteners, and thus the total cost will be inevitably increased.

Another solution is to combine the heat sink with the circuit board by means of screws. However, since the strength of the circuit board is smaller, such a manner may cause the circuit board to suffer damage due to the excessive locking force of the screw.

Therefore, a conventional elastic fixing device is proposed, as shown in FIG. 1, which is characterized in that a screw a is inserted into a spring b, the screw a is used to lock a heat sink c and a back plate e, so that the heat sink c can be tightly adhered to a processor f on a circuit board d. Since the screw a has been inserted in the spring b, the spring b will abut against the head of the screw a and a surface of the heat sink c. Owing to the elastic recovering force of the spring b and the locking force of the screw a, the heat sink c can be combined with the processor f on the circuit board d without an excessive locking force, thereby avoiding the circuit board d from suffering damage. However, such a solution still has a problem. That is, since the screw a and the spring b are made of metallic materials, the circuit board d and the heat sink c may become electrically conductive to generate a short circuit. As a result, the electronic element (not shown) on the circuit board d cannot operate normally, causing the breakdown of the circuit board d. Therefore, the Inventor attempts to overcome the above-mentioned problems.

### SUMMARY OF THE INVENTION

The present invention is to provide an elastic fastener for fixing a heat sink on a circuit board. A cylinder of the elastic fastener is made of electrically non-conductive material. With the electrically non-conductive property of the cylinder, the circuit board and the heat sink can be prevented from contacting to generate a short circuit. Thus, the breakdown of the circuit board and the heat sink can be avoided.

The present invention is to provide an elastic fastener for fixing a heat sink on a circuit board. The elastic fastener includes a fixing element, a cylinder and an elastic element. The fixing element has a head and a fixing section. One side of the fixing section is formed into a protruding ring. The cylinder is made of electrically non-conductive material, such as plastic, ceramic, rubber, glass or the like and it has a hollow hole for allowing the fixing element to pass through. The cylinder extends inwardly to form a locking ring for engagingly connecting with the protruding ring. The elastic fastener further includes an elastic element. Both ends of the elastic element are elastically compressed between the head and the top surface of the cylinder.

The present invention is to provide an elastic fastener for fixing a heat sink to a circuit board. With the elastic recovering force of the elastic element, the circuit board can be protected from suffering an excessive locking force exerted by the fixing element. Thus, the breakdown of the circuit board can be prevented.

### BRIEF DESCRIPTION OF THE DRAWINGS

FIG. 1 is a perspective view showing the structure of prior art;

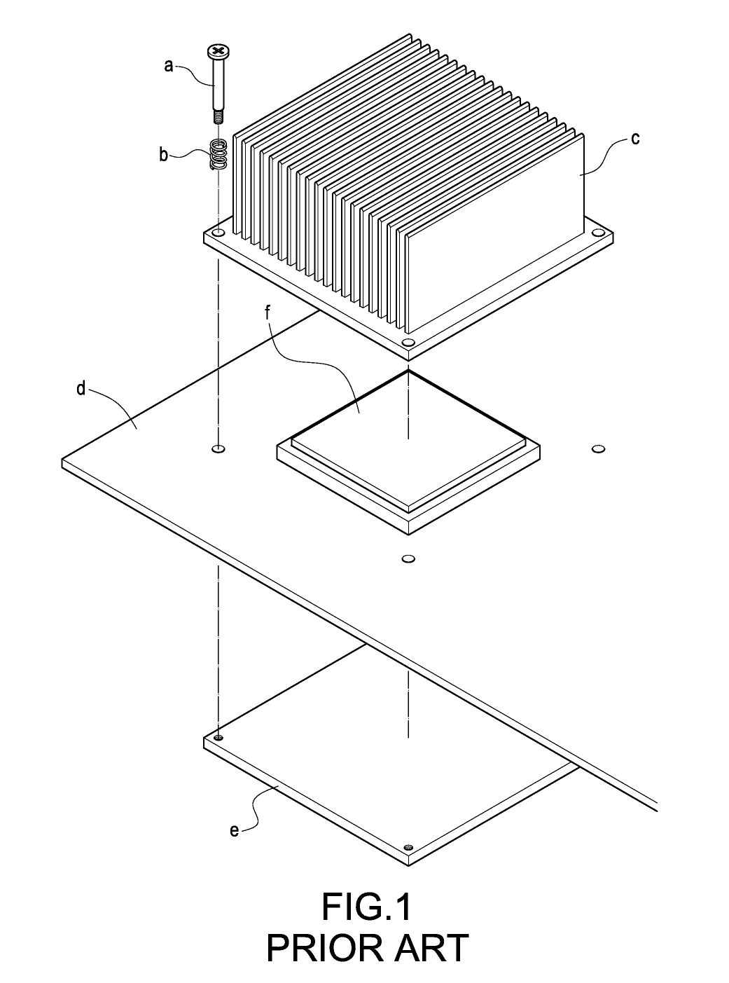

FIG. 2 is an exploded perspective view showing the first embodiment of the present invention;

FIG. 3 is a cross-sectional view showing the first embodiment of the present invention;

FIG. 4 is an exploded perspective view showing the first embodiment of the present invention being used for fixing a heat sink;

FIG. 5 is a cross-sectional view showing the first embodiment of the present invention being used for fixing a heat sink; and

FIG. 6 is a cross-sectional view showing the second embodiment of the present invention.

### DETAILED DESCRIPTION OF THE INVENTION

The detailed description and technical contents of the present invention will be explained with reference to the accompanying drawings. However, the drawings are illustrative only, but not used to limit the present invention.

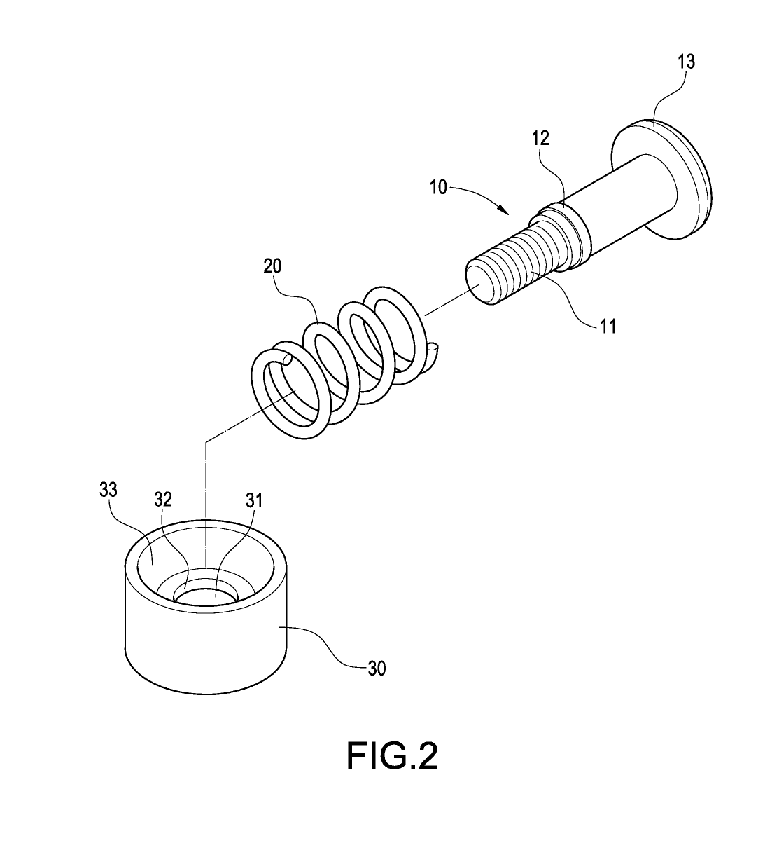

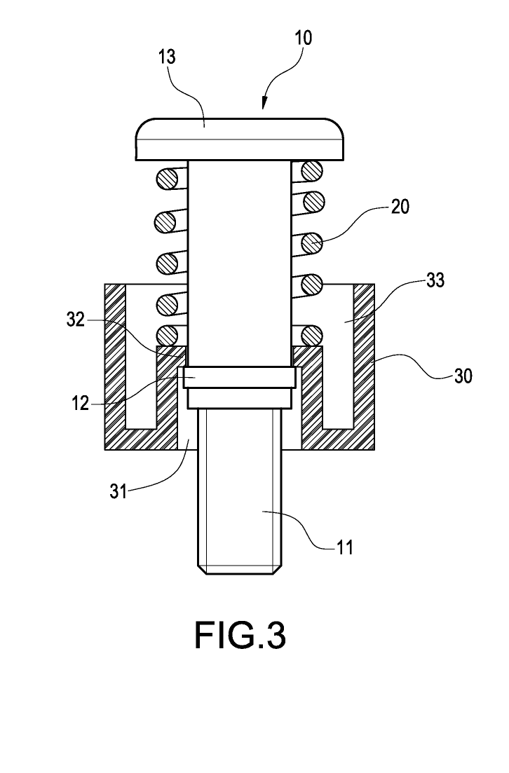

Please refer to FIGS. 2 and 3. FIG. 2 is an exploded perspective view showing the first embodiment of the present invention, and FIG. 3 is a cross-sectional view showing the first embodiment of the present invention. The present invention is to provide an elastic fastener for fixing a heat sink on a circuit board (such as a mother board). The elastic fastener includes a fixing element 10 having a fixing section 11 and a head 13. One side of the fixing section 11 is formed with a protruding ring 12. The elastic fastener further includes a cylinder 30. The cylinder is made of electrically non-conductive material, such as plastic, ceramic, rubber, glass or the like and it has a hollow hole 31 for allowing the fixing element 10 to pass through. The cylinder 30 extends inwardly to form a locking ring 32 for engagingly connecting with the protruding ring 12. The elastic fastener further includes an elastic element 20. The elastic element 20 can be a compression spring. Both ends of the elastic element 20 are elastically compressed between the head 13 and the top surface of the cylinder 30.

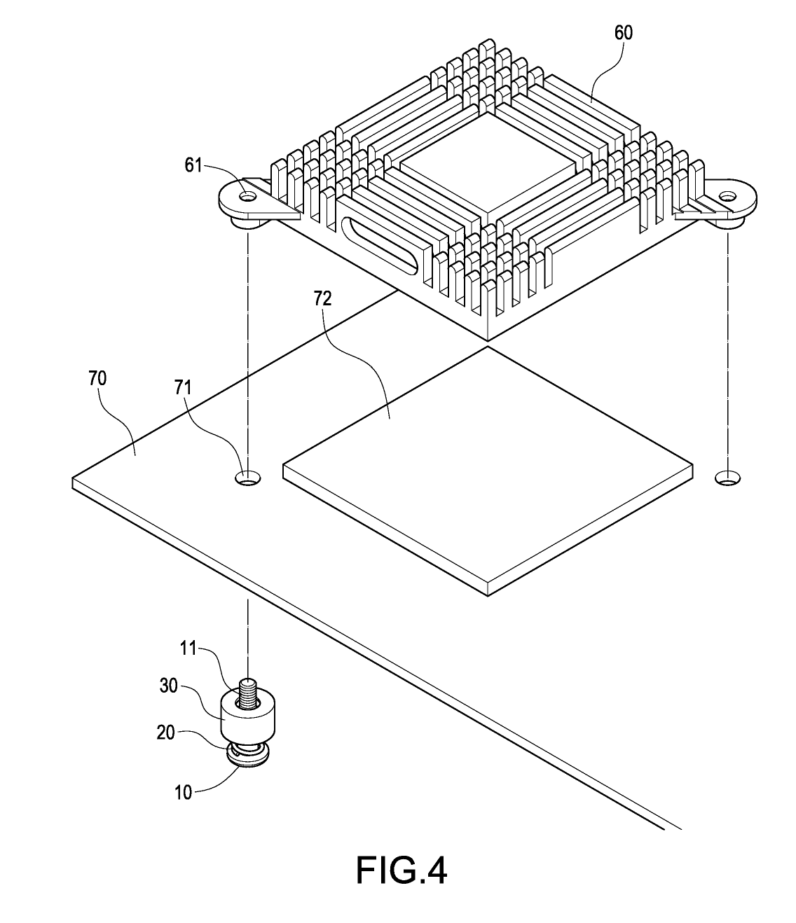

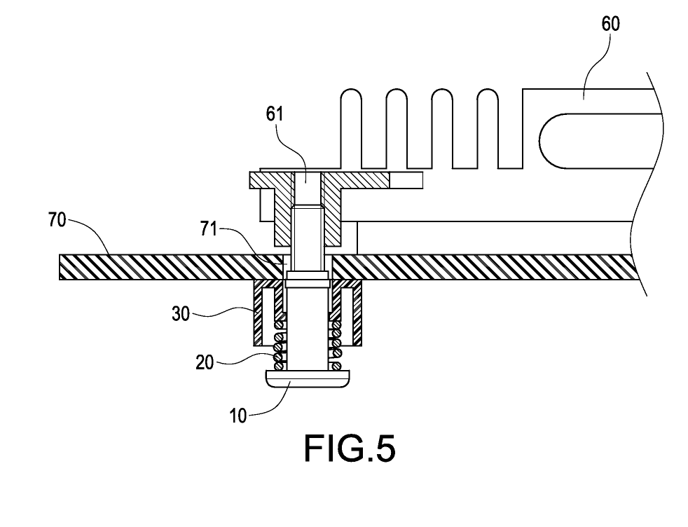

Please refer to FIGS. 4 and 5. FIG. 4 and FIG. 5 are an exploded perspective view and a cross-sectional respectively showing the first embodiment of the present invention being used for fixing a heat sink. In a heat-dissipating device of a common desktop computer, a heat sink 60 is adhered to a heat-generating element 72 on a circuit board 70. The elastic fastener is used to fix the heat sink 60 onto the circuit board 70. In use, the elastic fastener passes through a penetrating hole 71 of the circuit board 70 upwardly and is locked in a fixing hole 61 on one side of the heat sink 60. The top of the cylinder 30 is adhered to the bottom surface of the circuit board 70. At this time, the elastic element 20 is compressed to generate an elastic recovering force. This elastic recovering force can prevent the locking force between the fixing section 11 and the fixing hole 61 from becoming too large and thus can protect the circuit board 70 from suffering damage. Further, since the diameter of the penetrating hole 71 is larger than the diameter of the fixing section 11 of the fixing element 10, the fixing section 11 and the circuit board 70 are not brought into contact with each other. In this way, the electric current that flows through lines on the circuit board 70 can be prevented from directly flowing to the heat sink 60 via the fixing element 10 to generate a short circuit and in turn cause a breakdown of the circuit board 70. Further, due to the electrically non-conductive property of the cylinder 30, the cylinder 30 can be adhered to the bottom surface of the circuit board 70, so that the electric current flowing in the lines of the circuit board 70 can be blocked by the cylinder 30. As a result, the electric current that flows through the lines of the circuit board 70 can be prevented from flowing to the fixing element 10 and the elastic element 20 to generate a short circuit and in turn cause the breakdown of the circuit board 70.

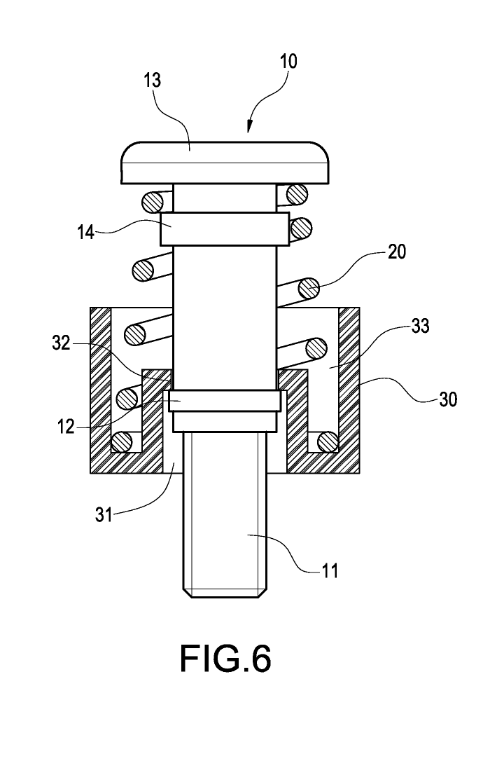

Please refer to FIG. 6, which is a cross-sectional view showing the second embodiment of the present invention. A fixing ring 14 is further formed between the head 13 and the protruding ring 12. The fixing ring 14 is used to fixedly engage with the elastic element 20. The top surface of the cylinder 30 is provided downwardly with a fixing trough 33 concentric with the hollow hole 31. The elastic element 20 is a conical compression spring with both ends being elastically compressed between the head 13 and the bottom of the fixing trough 33. The elastic element 20 utilizes its fixing ring 14 to fixedly engage with the fixing element 10. Furthermore, in the first embodiment, a fixing ring 14 is formed between the head 13 and the protruding ring 12, thereby positioning the elastic element 20 more precisely.

According to the above, the elastic fastener of the present invention already has industrial applicability, novelty and inventive steps. Furthermore, the present invention has not been seen in products of the same kind or let in public use. Therefore, the present invention conforms to the requirements for a utility model patent.

What is claimed is:

1. An elastic fastener, comprising:
a fixing element having a head and a fixing section, one side of the fixing section being formed with a protruding ring;
a cylinder having a hollow hole for allowing the fixing element to pass through, the cylinder extending inwardly to form a locking ring, the locking ring being engagingly connected with the protruding ring; and
an elastic element with both ends thereof being elastically compressed between the head and the cylinder.

2. The elastic fastener according to claim 1, wherein elastic element is a compression spring.

3. The elastic fastener according to claim 1, wherein the cylinder is formed with a fixing trough concentric with the hollow hole, thereby compressing the elastic element.

4. The elastic fastener according to claim 1, wherein the cylinder is made of plastic.

5. The elastic fastener according to claim 1, wherein the cylinder is made of ceramic.

6. The elastic fastener according to claim 1, wherein the cylinder is made of rubber.

7. The elastic fastener according to claim 1, wherein the cylinder is made of glass.

8. An elastic fastener, comprising:
a fixing element having a head and a fixing section, one side of the fixing section being formed with a protruding ring, a fixing ring being formed between the head and the protruding ring;
a cylinder having a hollow hole for allowing the fixing element to pass through, the cylinder extending inwardly to form a locking ring, the locking ring being engagingly connected with the protruding ring; and
an elastic element fixedly engaged with the fixing ring, both ends of the elastic element being elastically compressed between the head and the cylinder.

9. The elastic fastener according to claim 8, wherein the elastic element is a conical compression spring.

10. The elastic fastener according to claim 8, wherein the cylinder is formed with a fixing trough concentric with the hollow hole, thereby compressing the elastic element.

11. The elastic fastener according to claim 8, wherein the cylinder is made of plastic.

12. The elastic fastener according to claim 8, wherein the cylinder is made of ceramic.

13. The elastic fastener according to claim 8, wherein the cylinder is made of rubber.

14. The elastic fastener according to claim 8, wherein the cylinder is made of glass.
